(19) United States
(12) Patent Application Publication
(10) Pub. No.: US 2007/0251959 A1
(43) Pub. Date: Nov. 1, 2007

(54) SPICE DISPENSING FLIP CAP DEVICE

(75) Inventor: Jeremy Brotchner, Forest Hills, NY (US)

Correspondence Address: TROUTMAN SANDERS LLP, 600 PEACHTREE STREET , NE, ATLANTA, GA, 30308, US

(73) Assignee: Lifetime Brands, Inc., Westbury, NY (US)

(21) Appl. No.: 11/613,581

(22) Filed: Dec. 20, 2006

Related U.S. Application Data
(60) Provisional application No. 60/752,622, filed on Dec. 21, 2005.

(51) Int. Cl. B65D 47/00; B67B 7/00; B67D 3/00

(52) U.S. Cl. 222/534; 222/556

(57) ABSTRACT

A dispensing flip cap device for dispensing the contents of a container. The dispensing flip cap device includes a sifting and pouring insert having a closed position, a sifting position (a first open position), and a pouring position (a second open position); a dispensing sleeve adapted to receive the sifting and pouring insert; and a locking system for maintaining the sifting and pouring insert in the closed, sifting, and pouring positions. In the sifting and pouring positions, the contents can be dispensed from the inside to the outside of the container, but, in the closed position, the contents cannot be dispensed to the outside of the container. Further, the dispensing rate of the contents of the container is greater when the sifting and pouring insert is in the pouring position than when the sifting and pouring insert is in the sifting position.

### CROSS REFERENCE TO RELATED APPLICATION

This application claims priority of U.S. Provisional Patent Application No. 60/752,622 filed 21 Dec. 2005, the entire contents of which is hereby incorporated by reference.

### TECHNICAL FIELD

The present invention relates generally to a dispensing device for a container, and in particular to a dispensing flip cap device for a spice container that can be manipulated with one hand.

### BACKGROUND OF THE INVENTION

Dispensing containers are used in a variety of industries, for many different purposes. Generally, dispensing containers contain specific contents, such as liquids or particulates, which can be dispensed by an individual when desired. To prevent the contents of the container from being dispensed accidentally, many dispensing containers include a cap or lid that remains on the container during periods of nonuse.

In the food industry, dispensing containers that contain solid foods, such as herbs or spices, in granular or powder-like form, are commonly used. Dispensing containers are often bountiful in the kitchen, containing such materials as salt, pepper, basil, cinnamon, dill, mustard powder, garlic salt or powder, ginger, thyme, rosemary, nutmeg, oregano, paprika, parsley, saffron, and turmeric, just to name a few. Such materials are key ingredients in a variety of recipes for various foods.

In the culinary arts, a busy kitchen can be the focal point of creation, disarray, and demanding conditions. Amateur and professional chefs are often required to multitask during the cooking and/or creation process. For example, a cook may be stirring a substance with one hand, while adding additional ingredients with the other hand. Additionally, only one clean hand may be available for handling dispensing containers and utensils, because the other hand has been handling or preparing the food ingredients.

Typical dispensing containers, however, require the use of two hands for both removing the cap or lid of the dispensing container, and putting the cap or lid back on the dispensing container after use. Cooks are often left with the dilemma of either taking the chance of opening the dispensing container with dirty hands, or halting the food preparation process to wash or wipe their hands before handling the dispensing container. When a cook opens the dispensing container with dirty hands, the process often involves an awkward handling of the dispensing container in an attempt to not get the dispensing container dirty.

What is needed is a dispensing flip cap device for a container that can be opened and closed easily with the use of only one hand, while adequately enabling the dispensing of contents in the open position, and securing the contents within the container in the closed position. Further, what is needed is a dispensing flip cap device that can be adjusted to a sifting position or a pouring position with the use of only one hand. It is to such a device that the present invention is primarily directed.

### BRIEF SUMMARY OF THE INVENTION

Briefly described, the present invention is a dispensing flip cap device for dispensing the contents of a container. The dispensing flip cap device includes a sifting and pouring insert having a closed position, a sifting position (a first open position), and a pouring position (a second open position); a dispensing sleeve adapted to receive the sifting and pouring insert; and a locking system for maintaining the sifting and pouring insert in the closed, sifting, and pouring positions. In the sifting and pouring positions, the contents can be dispensed from the inside to the outside of the container, but, in the closed position, the contents cannot be dispensed to the outside of the container. Further, the dispensing rate of the contents of the container is greater when the sifting and pouring insert is in the pouring position than when the sifting and pouring insert is in the sifting position.

The sifting and pouring insert is adapted to pivot within the dispensing sleeve, such that a downward force applied to a rear portion of the sifting and pouring insert causes the front portion of the sifting and pouring insert to move upwards. The front portion of the sifting and pouring insert is formed to define a plurality of small sifting apertures and a larger pouring aperture, such that when the sifting and pouring insert is in the sifting position the contents of the container can flow through the plurality of small sifting apertures, and when the sifting and pouring insert is in the pouring position the contents of the container can flow through the larger pouring aperture.

The dispensing flip cap device can further include a cap cover and a housing adapted to engage the container and receive the dispensing sleeve. The interoperability of the housing and the dispensing sleeve prevent rotational movement of the sifting and pouring insert during use of the dispensing flip cap device. The cap cover includes an indentation and a plurality of ridges located near the rear portion of the cap cover, such that a downward force is applied to the indentation of the cap cover to move the sifting and pouring insert from the closed position to the sifting and pouring positions. Further, the cap cover and housing can be easily interchanged to provide different styles, colors, or shapes.

In operation, beginning with the sifting and pouring insert in the closed position, a first downward force is applied to the indentation of the cap cover, whereby the front portion of the sifting and pouring insert moves upward. The locking system temporarily disengages from the closed position, while the sifting and pouring insert is moved to the sifting position where the locking system engages and maintains the sifting and pouring insert in the sifting position. A second downward force applied to the indentation of the cap cover causes the locking system to temporarily disengage from the sifting position, while the sifting and pouring insert is moved to the pouring position where the locking system engages and maintains the sifting and pouring insert in the pouring position.

A third downward force applied to the front portion of the cap cover causes the sifting and pouring insert to rotate in an opposite direction, such that the front portion of the sifting and pouring insert begins to move downward. The locking system temporarily disengages from the pouring position and the sifting and pouring insert moves to the sifting position, where the locking system then engages the sifting and pouring insert in the sifting position. A fourth downward force applied to the front of the cap cover causes the locking system to temporarily disengage from the sifting position, while the sifting and pouring insert is moved to the closed position where the locking system then engages to maintain the sifting and pouring insert in the closed position.

A principle object of the present invention is to provide a dispensing flip cap device that can be moved between an open and closed position with only one hand activation.

Another object of the present invention is to provide a dispensing flip cap device that allows the contents of a container to be dispensed outside the container when the dispensing device is in the open position, but not the closed position.

Still another object of the present invention is to provide a dispensing flip cap device that can be moved between a pouring, sifting and pouring position, such that the dispensing rate of contents from the container is greater when in the pouring position than in the sifting position.

It is another object of the present invention to provide a dispensing flip cap device that can be moved between the closed position, sifting position, and pouring position by pressing the top of the dispensing flip cap device by using only one hand.

Yet another object of the present invention is to provide a sifting and pouring insert defining one or more apertures adapted to allow the contents of the container to be dispensed when the sifting and pouring insert is in the open position, but not the closed position.

Still another object of the present invention is to provide a cap cover and housing that can be easily replaced for style, color, and shape.

It is another object of the invention to provide a dispensing sleeve and housing that prevent rotational movement of the sifting and pouring insert during use.

Yet another object of the present invention is to provide a locking system that temporarily maintains the sifting and pouring insert in the closed, sifting, and pouring positions.

These and other objects, features and advantages of the present invention will become more apparent upon reading the following specification in conjunction with the accompanying drawings.

### BRIEF DESCRIPTION OF THE FIGURES

FIGS. 1A-1C, collectively known as FIG. 1, illustrate perspective views of a dispensing flip cap device having a closed position, a sifting position, and a pouring position, in accordance with exemplary embodiments of the present invention.

FIGS. 2A-2B, collectively known as FIG. 2, illustrate an exploded view and a collapsed view of a dispensing flip cap device in accordance with exemplary embodiments of the present invention.

FIG. 3 illustrates a perspective view of a cap cover in accordance with exemplary embodiments of the present invention.

FIGS. 4A-4C, collectively known as FIG. 4, illustrate perspective views of a sifting and pouring system in accordance with exemplary embodiments of the present invention.

FIGS. 5A-5B, collectively known as FIG. 5, illustrate perspective and sectional views of a dispensing sleeve in accordance with exemplary embodiments of the present invention.

FIG. 6 illustrates a perspective view of a housing in accordance with exemplary embodiments of the present invention.

### DETAILED DESCRIPTION OF THE PREFERRED EMBODIMENTS

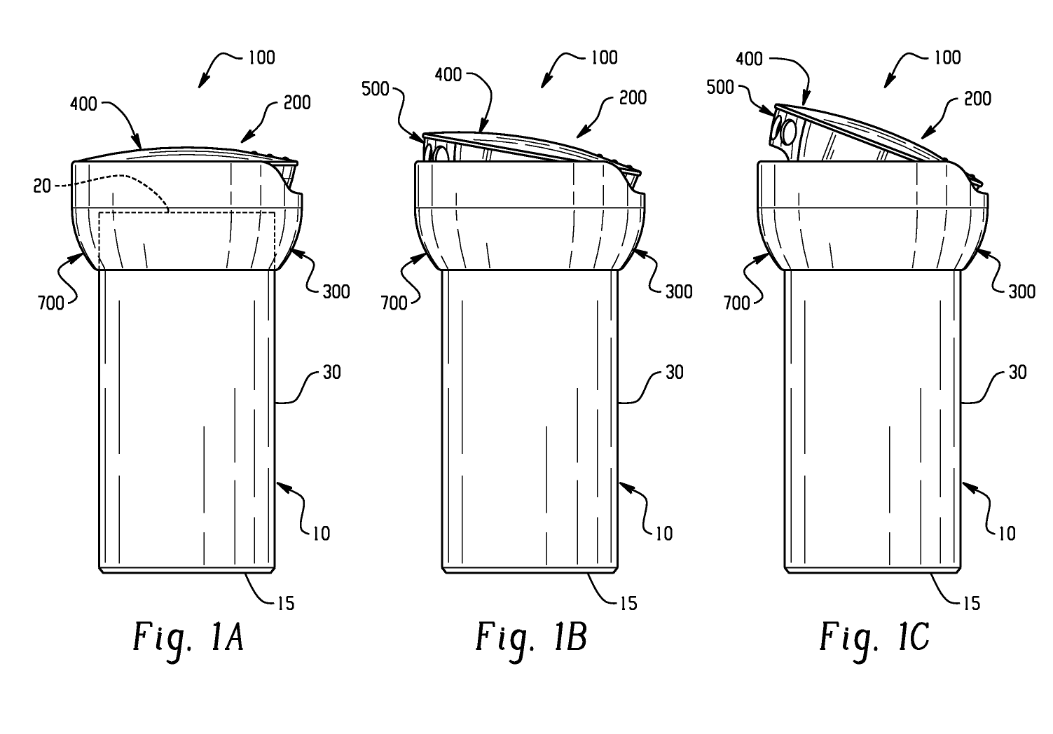

Referring now in detail to the drawing figures, wherein like reference numerals represent like parts throughout the several views, a dispensing flip cap device 100 of FIG. 1 utilizes a container 10, typically a cylindrical glass spice container. The dispensing flip cap device 100 is designed for allowing contents within the container 10, such as herbs or spices, to be dispensed from the inside of the container 10 to the outside of the container 10 when the dispensing flip cap device 100 is in an open position, but prevents contents within the container 10 from being dispensed to the outside of the container 10 when the dispensing flip cap device 100 is in a closed position. The dispensing flip cap device 100 can be configured for containers 10 of varying sizes and shapes. Generally, the dispensing flip cap device 100 is configured for a spice container 10 having an upper open end 20, a bottom 15, and a peripheral wall 30 extending upwardly from the bottom 15 to the upper open end 20.

As shown in FIGS. 1A-1C, the dispensing flip cap device 100 can be moved between a closed position, a sifting position (a first open position), and a pouring position (a second open position). In the sifting position, the contents of the container 10 can be dispensed from the inside of the container 10 to the outside of the container 10 at a first rate of dispensing. In the pouring position, the contents of the container 10 can be dispensed from the inside of the container 10 to the outside of the container 10 at a second rate of dispensing. Typically, the first rate of dispensing is less than the second rate of dispensing. Accordingly, the rate of dispensing the contents of the container 10 in the sifting position is less than the rate of dispensing the contents of the container 10 in the pouring position.

During use, an individual can determine whether the dispensing flip cap device 100 is in the closed position, sifting position, or pouring position without actually looking at the dispensing flip cap device 100. The present invention, therefore, provides an easy-to-use dispensing device that can be moved between the closed position, sifting position, and pouring position with one hand, thereby permitting the individual using the dispensing flip cap device 100 to concentrate on other matters, such as preparing or cooking the food.

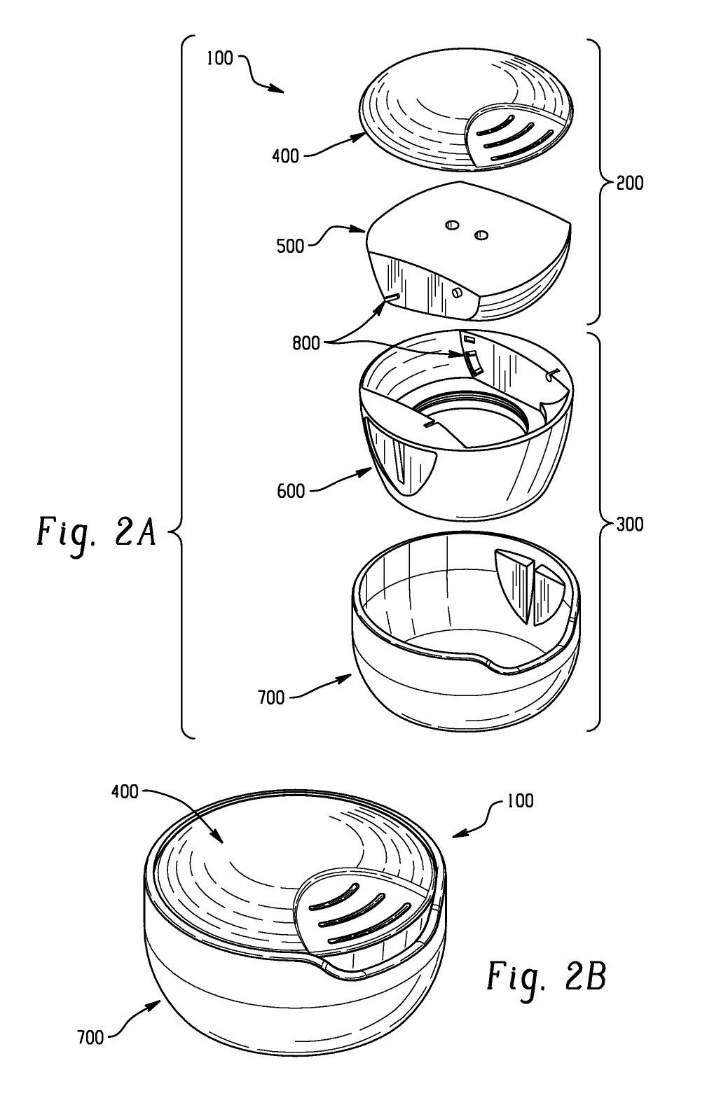

As illustrated in FIGS. 1A-1C and 2A-2B, the dispensing flip cap device 100 comprises a top assembly 200, a bottom assembly 300, and a locking system 800. The bottom assembly 300 is adapted to engage the upper open end 20 of the container 10. The top assembly 200 is receivable within the bottom assembly 300, such that the top assembly 200 is adapted to pivot within the bottom assembly 300, thereby moving the dispensing flip cap device 100 between the closed position, sifting position, and pouring position. The locking system 800 is adapted to temporarily maintain the top assembly 200 in the closed position, sifting position, and pouring position. The locking system 800, therefore, ensures that the dispensing flip cap device 100 does not inadvertently move between the closed position, sifting position, and pouring position (e.g., undesirable movement during use and non-use).

The top assembly 200 comprises a cap cover 400 and a sifting and pouring insert 500 that permits contents of the container 10 to move from the inside of the container 10 to the outside of the container 10 when the sifting and pouring insert 500 is moved or pivoted to the sifting position or pouring position. The bottom assembly 300 comprises a dispensing sleeve 600 and a housing 700, such that the dispensing sleeve 600 is receivable within the housing 700. The dispensing sleeve 600 is adapted to engage the upper open end 20 of the container 10.

The locking system 800 of the dispensing flip cap device 100 comprises the interplay between the sifting and pouring insert 500 of the top assembly 200 and the dispensing sleeve 600 of the bottom assembly 300. The top assembly 200 is activated by applying a downward force to a back portion of the cap cover 400. As the back portion of the cap cover 400 is moved downward, the front portion of the cap cover 400 moves upward as the top assembly 200 pivots.

The locking system 800 temporarily disengages so that the sifting and pouring insert 500 can move or pivot from the closed position to the sifting position. Then, the locking system 800 reengages to maintain the sifting and pouring insert 500 in the sifting position. An additional downward force to the back portion of the cap cover 400 permits the locking system 800 to temporarily disengage so that the sifting and pouring insert 500 can move or pivot from the sifting position to the pouring position. Once the sifting and pouring insert 500 reaches the pouring position, the locking system 800 reengages to maintain the sifting and pouring insert 500 in the pouring position.

In an exemplary embodiment of the present invention, the sifting and pouring insert 500 is formed to define one or more dispensing apertures 520, 525. The dispensing apertures 520, 525 are in communication with the inside of the container 10, but not the outside of the container 10, when the dispensing flip cap device 100 is in the closed position. Accordingly, the contents of the container 10 cannot be dispensed outside the container 10 when the dispensing flip cap device 100 is in the closed position. The dispensing apertures 520, 525 are in communication with the inside and outside of the container 10 when the dispensing flip cap device 100 is in the open position (e.g., the sifting position or the pouring position). When in the open position, the contents of the container 10 can be dispensed from the inside of the container 10 to the outside of the container 10.

More specifically, the top assembly 200 of the dispensing flip cap device 100 comprises a cap cover 400 and a sifting and pouring insert 500. The bottom assembly 300 of the dispensing flip cap device 100 comprises a dispensing sleeve 600 and a housing 700. The container 10 interfaces with the dispensing sleeve 600 of the dispensing flip cap device 100. The dispensing sleeve 600 has a lower open end 610 adapted to engage the upper open end 20 of the container 10.

The sifting and pouring insert 500 is adapted to allow the contents within the container 10 to be dispensed to the outside of the container 10. In other words, the sifting and pouring insert 500 can provide a passage or channel between the inside of the container 10 and the outside of the container 10, so that the contents of the container 10 can be easily removed or dispensed from within the container 10. Further, the sifting and pouring insert 500 can be partially extended outside of the bottom assembly 300 as the sifting and pouring insert 500 pivots within the dispensing sleeve 600.

FIGS. 2A-2B illustrate the various components of the dispensing flip cap device 100 and an exemplary assembly of these components during use of the flip cap device 100. More specifically, the housing 700 is adapted to receive the dispensing sleeve 600, which is adapted to receive the sifting and pouring insert 500. The cap cover 400 can be placed over the sifting and pouring insert 500, whereby the cap cover 400 adequately engages an upper portion of the housing 700. Each of the components of the dispensing flip cap device 100 is described more fully below with reference to the corresponding drawings.

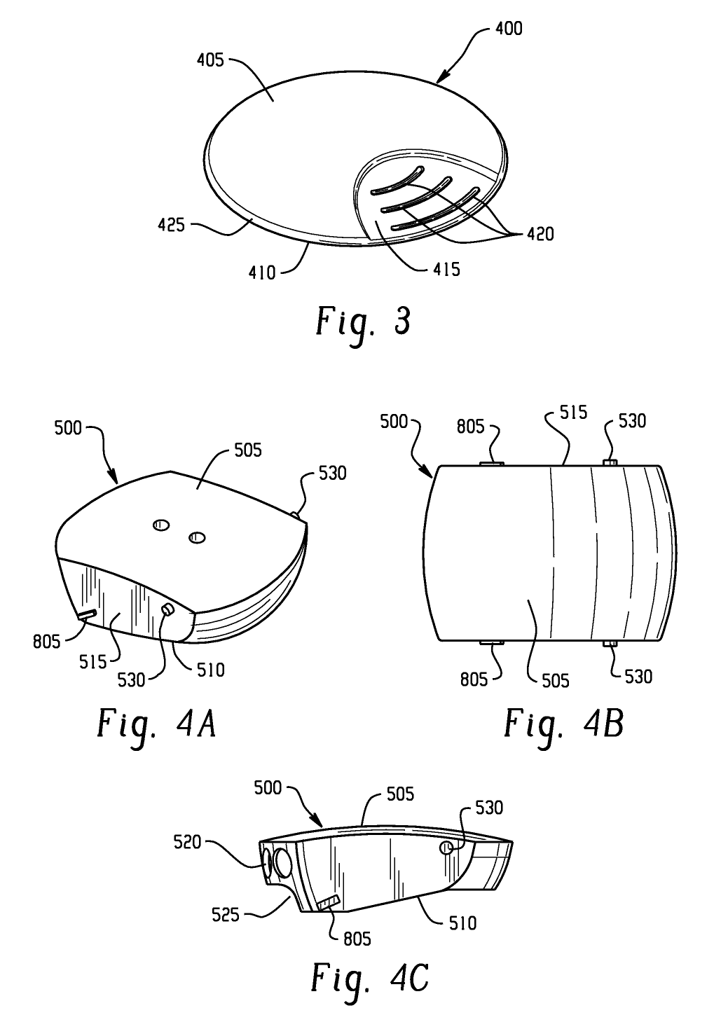

As illustrated in FIG. 3, the cap cover 400 comprises a top 405, a bottom 410, and a thin peripheral wall or ridge 425 around the perimeter of the cap cover 400. The ridge 425 is in communication with the top 405 and the bottom 410 of the cap cover 400. The top 405 of the cap cover 400 includes an indentation 415, such that the indentation 415 is positioned near a rear edge of the top 405. The indentation 415 can include a plurality of ridges 420 adapted to provide grip or traction for an individual's finger when pushing downwardly on the indentation 415 of the cap cover 400. As a downward force is applied to the indentation 415 of the cap cover 400, the sifting and pouring insert 500 pivots within the dispensing sleeve 600, thereby moving the sifting and pouring insert 500 from the closed position to the sifting or pouring position. Further, the cap cover 400 is adapted to fit snuggly (or snap) into the upper portion of the housing 700, such that the cap cover 400 encapsulates the sifting and pouring insert 500 and the dispensing sleeve 600 within the housing 700 during use.

The sifting and pouring insert 500, as illustrated in FIGS. 4A-4C, comprises a closed upper end (or top) 505, an open lower end (or bottom) 510, and a peripheral edge 515 extending downwardly from the closed upper end 505 to the open lower end 510, thereby forming a cavity within the sifting and pouring insert 500 below the closed upper end 505. Such a cavity permits the contents of the container 10 to flow from the inside of the container 10 to the outside of the container 10 when the sifting and pouring insert 500 is in the open position.

The peripheral edge 515 is formed to defined a plurality of small apertures (e.g., sifting holes) 520 and a large aperture (e.g., pouring hole) 525, such that the plurality of small apertures 520 and the large aperture 525 are positioned near a front side of the sifting and pouring insert 500. More specifically, the plurality of small apertures 520 is positioned above the large aperture 525, whereby the small apertures 520 allow contents within the container 10 to flow from the inside of the container 10 to the outside of the container 10 when the sifting and pouring insert 500 is in the sifting position, and the large aperture 525 allows contents within the container 10 to flow from the inside of the container 10 to the outside of the container 10 when the sifting and pouring insert 500 is in the pouring position. Moreover, the contents within the container 10 can flow from the inside to the outside of the container 10 at a first dispensing rate when flowing through the plurality of small apertures 520 and at a second dispensing rate when flowing through the large aperture 525. Typically, the second dispensing rate (pouring) is greater than the first dispensing rate (sifting).

The peripheral edge 515 of the sifting and pouring insert 500 further comprises a plurality of pivot tabs 530 adapted to permit the sifting and pouring insert 500 to move between the closed position, sifting position, and pouring position. Generally, a first pivot tab 530 extends outwardly from a first outer side of the peripheral edge 515, while a second pivot tab 530 extends outwardly from a second, opposite outer side of the peripheral edge 515. The first pivot tab 530 and the second pivot tab 530 are substantially aligned along a horizontal axis, thereby creating a substantially linear pivot axis at which the sifting and pouring insert 500 can pivot upwardly and downwardly within the dispensing sleeve 600. When the sifting and pouring insert 500 moves from the closed position to the sifting position, the plurality of small apertures 520 creates an open channel between the outside of the container 10 and the inside of the container 10. When the sifting and pouring insert 520 is in the pouring position, the large aperture 520 creates an open channel between the outside of the container 10 and the inside of the container 10.

One skilled in the art will recognize that the one large aperture 525 permits a substantial amount of contents to be dispensed from the container 10 in a short period of time, while the plurality of small apertures 520 permits a smaller amount of contents to be dispensed from the container 10 in the same period of time.

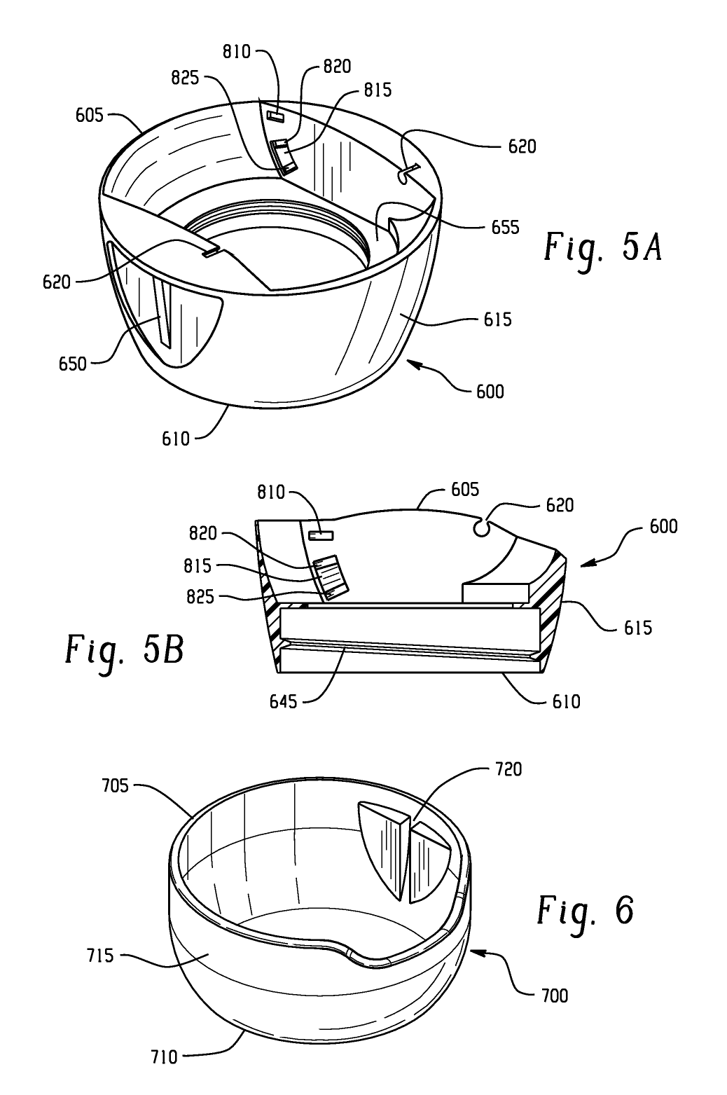

As illustrated in FIGS. 5A-5B, the dispensing sleeve 600 comprises an open upper end (a top) 605, an open lower end (a bottom) 610, and a peripheral side wall 615 extending from the open upper end 605 to the open lower end 610, thereby forming a channel or cavity within the dispensing sleeve 600. The formed channel permits the contents of the container 10 to flow from the inside of the container 10 to the sifting and pouring insert 500, where the contents can then flow to the outside of the container 10 if the sifting and pouring insert 500 is in the open position.

The dispensing sleeve 600 further comprises a plurality of pivot grooves 620 adapted to adequately engage the plurality of pivot tabs 530 of the sifting and pouring insert 500. Generally, the plurality of pivot tabs 530 of the sifting and pouring insert 500 are received by (or snap into) the plurality of pivot grooves 620 of the dispensing sleeve 600. The plurality of pivot grooves 620, therefore, assists in maintaining the sifting and pouring insert 500 within the dispensing sleeve 600, but, at the same time, allows the sifting and pouring insert 500 to adequately pivot between the closed, sifting, and pouring positions. The plurality of pivot grooves 620 are positioned on the peripheral side wall 615 near the open upper end 605 of the dispensing sleeve 600. Typically, a first pivot groove 620 is positioned on a first inner side of the peripheral side wall 615, while a second pivot groove 620 is positioned on a second, opposite inner side of the peripheral side wall 615. The first pivot groove 620 and the second pivot groove 620 are aligned along a substantially linear axis, thereby permitting the sifting and pouring insert 500 to pivot along the substantially linear pivot axis defined by the plurality of pivot tabs 530.

The dispensing sleeve 600 can include a helical thread 645 in communication with the inner side of the peripheral side wall 615, such that the helical thread 645 is positioned near the open lower end 610 of the dispensing sleeve 600. Likewise, the outer side of the upper open end 20 of the container 10 comprises a similar thread, so that the dispensing sleeve 600 can easily be screwed on and off of the container 10 during attachment.

To assist in the engagement of the dispensing sleeve 600 with the housing 700, the dispensing sleeve 600 can further include a plurality of housing tabs 650 extending outwardly from the outer side of the peripheral side wall 615. For example, a first housing tab 650 can extend outwardly from a first outer side of the peripheral side wall 615, while a second housing tab 650 extends outwardly from a second, opposite outer side of the peripheral side wall 615. The plurality of housing tabs 615 is adapted to engage the housing 700 and, thereby, maintain the dispensing sleeve 600 in engagement with the housing 700. The plurality of housing tabs 615 are also adapted to prevent the dispensing sleeve 600 from rotating within the housing 700 during use of the dispensing flip cap device 100.

To facilitate proper engagement of the sifting and pouring insert 500 with the dispensing sleeve 600, the dispensing sleeve can comprise an inner ridge 655 positioned along the inner side of the peripheral side wall 615. The inner ridge 655 extends outwardly from the peripheral side wall 615 into the cavity or channel defined within the dispensing sleeve 600. The inner ridge 655 is positioned within the dispensing sleeve 600, such that the sifting and pouring insert 500 is seated upon the inner ridge 655 when received by the dispensing sleeve 600. Moreover, the inner ridge 655 is positioned so that the closed upper end 505 of the sifting and pouring insert 500 is generally flush (or level) with the upper open end 605 of the dispensing sleeve 600, when the sifting and pouring insert 500 is received within the dispensing sleeve 600 and the sifting and pouring insert 500 is in the closed position.

As illustrated in FIG. 6, the housing 700 comprises an open upper end 705, an open lower end 710, and a peripheral side wall 715 extending from the open upper end 705 to the open lower end 710, thereby forming a channel or cavity within the housing 700. The housing 700 is adapted to receive the dispensing sleeve 600. Accordingly, the housing 700 includes a plurality of housing grooves 720 positioned along the inner side of the peripheral side wall 715. The plurality of housing grooves 720 is adapted to adequately engage the plurality of housing tabs 650 of the dispensing sleeve 600. During use, the plurality of housing grooves 720 maintains the dispensing sleeve 600 within the housing 700 and prevents rotational movement of the dispensing sleeve 600. For example, a first housing groove 720 can be positioned on a first inner side of the peripheral side wall 715 of the housing 700, while a second housing groove 720 is positioned on a second, opposite inner side of the peripheral side wall 715. As positioned, the plurality of housing grooves 720 is aligned appropriately with the plurality of housing tabs 650 of the dispensing sleeve 600 to ensure proper engagement when the dispensing sleeve 600 is received within the housing 700.

Further, a portion of the peripheral side wall 715 of the housing 700 can be cut away, so that an individual can more easily apply a downward force onto the indentation 415 of the cap cover 400. The cut away portion of the peripheral side wall 715 can be generally positioned near the back or rear of the housing 700, such that, when assembled, the indentation 415 of the cap cover 400 is positioned near the cut away portion of the peripheral side wall 715. Further, the cut away portion of the peripheral side wall 715 can assist in preventing the sifting and pouring insert 500 from moving outwardly beyond the pouring position (such that the sifting and pouring insert 500 disengages with the dispensing sleeve 600) by hindering an individual from applying a downward force when the sifting and pouring insert 500 is in the pouring position. More specifically, the indentation 415 of the cap cover 400 is generally flush (or level) with the peripheral side wall 715 of the housing 700 (at the position of the cut away) when the sifting and pouring insert 500 is in the pouring position, thereby making it difficult for an individual to continue to apply a downward force on the indentation 415 of the cap cover 400.

The locking system 800, as illustrated in FIGS. 2A, 4A-4C, and 5A-5B, is adapted to temporarily maintain the sifting and pouring insert 500 in the closed position, sifting position, and pouring position during use of the dispensing flip cap device 100. As configured, the locking system 800 ensures that the sifting and pouring insert 500 does not undesirably move between the closed, sifting, and pouring position without the intention of the individual using the dispensing flip cap device 100. As described above, the locking system 800 includes the interoperability of the sifting and pouring insert 500 and the dispensing sleeve 600.

The locking system 800 comprises a plurality of position catches 805, a plurality of upper position detents 810, a plurality of lower position grooves 815, a plurality of middle position detents 820, and a plurality of lower position detents 825. The plurality of position catches 805 is adapted to temporarily engage: the plurality of lower position detents 825 when the sifting and pouring insert 500 is in the closed position, the plurality of middle position detents 820 when the sifting and pouring insert 500 is in the sifting position, and the plurality of upper position detents 810 when the sifting and pouring insert is in the pouring position.

In an exemplary embodiment, the plurality of position catches 805 can extend from the outer sides of the peripheral side wall 515 of the sifting and pouring insert 500. For example, a first position catch 805 extends outwardly from a first outer side of the peripheral side wall 515 of the sifting and pouring insert 500, while a second position catch 805 extends outwardly from a second, opposite outer side of the peripheral side wall 515. The position catches 805 can be positioned near the front portion of the sifting and pouring insert 500, whereby the position catches 805 are located near the open lower end 510 of the sifting and pouring insert 500.

The plurality of upper position detents 810, plurality of lower position grooves 815, plurality of middle position detents 820, and plurality of lower position detents 825 can be positioned or formed on the inner side of the peripheral side wall 615 of the dispensing sleeve 600. For example, a first upper position detent 810, a first middle position detent 820, a first lower position detent 825, and a first lower position groove 815 are positioned or formed on a first inner side of the peripheral side wall 615 of the dispensing sleeve 600, while a second upper position detent 810, a second middle position detent 820, a second lower position detent 825, and a second lower position groove 815 are positioned or formed on a second, opposite inner side of the peripheral side wall 615 of the dispensing sleeve 600.

The upper position detents 810, lower position grooves 815, middle position detents 820, and lower position detents 825 can be positioned near the front portion of the dispensing sleeve 600, whereby the position catches 805 of the sifting and pouring insert 500 can temporarily engage any of the detents 810, 820, 825 or grooves 815 when the sifting and pouring insert 500 is received within the dispensing sleeve 600.

The upper position detents 810 are positioned near the open upper end 605 of the dispensing sleeve 600, such that the sifting and pouring insert 500 is in the pouring position when the position catches 805 engage the upper position detents 810. The lower position detents 825 are positioned near the open lower end 610 of the dispensing sleeve 600, such that the sifting and pouring insert 500 is in the closed position when the position catches 805 engage the lower position detents 825. The middle position detents 820 are positioned between the lower position detents 825 and the upper position detents 810, such that the sifting and pouring insert 500 is in the sifting position when the position catches 805 engage the middle position detents 820. The lower position grooves 815 are positioned between the lower position detents 825 and the middle position detents 820, such that the lower position grooves 815 assist in the movement or rotation of the position catches 805 between the lower position detents 825 and the middle position detents 820.

As the sifting and pouring insert 500 is adapted to pivot along a substantially linear pivot axis, the upper position detents 810, lower position grooves 815, middle position detents 820, and lower position detents 825 can be aligned along an arcuate path in coordination with the arcuate path of the front portion of the sifting and pouring insert 500.

To assist in proper engagement of the position catches 805 with the upper position detents 810, lower position grooves 815, middle position detents 820, and lower position detents 825, a portion of the inner side of the peripheral side wall 615 of the dispensing sleeve 600 and a portion of the outer side of the peripheral side wall 515 of the sifting and pouring insert 500 can be relatively flat. Accordingly, when the sifting and pouring insert 500 is received by the dispensing sleeve 600, the flat portion of the peripheral side wall 615 of the dispensing sleeve 600 is substantially parallel with the flat portion of the peripheral side wall 515 of the sifting and pouring insert 500. Such a configuration facilitates a more reliable engagement of the position catches 805 with the upper position detents 810, lower position grooves 815, middle position detents 820, and lower position detents 825.

In use, with the sifting and pouring insert 500 in the closed position, a first downward force is applied to the indentation 415 of the cap cover 400. Such a downward force causes the position catches 805 to temporarily disengage with the lower position detents 825. As the sifting and pouring insert 500 pivots along the substantially linear pivot axis (defined by the pivot tabs 530 and the pivot grooves 620), the front portion of the sifting and pouring insert 500 begins to move upward. The position catches 805 slide along the lower position grooves 815 that guide the position catches 805 to the middle position detents 820. The position catches 805 then engage with the middle position detents 820, whereby the sifting and pouring insert 500 is temporarily maintained in the sifting position.

As a second downward force (or a continuing first downward force) is applied to the indentation 415 of the cap cover 400, the position catches 805 temporarily disengage with the middle position detents 820 and the front portion of the sifting and pouring insert 500 continues to move upward. The position catches 805 then engage with the upper position detents 810, whereby the sifting and pouring insert 500 is temporarily maintained in the pouring position.

After dispensing a portion of the contents of the container 10, an individual can apply a third downward force to the front portion of the cap cover 400. Such a downward force causes the sifting and pouring insert 500 to pivot in the opposite direction and, therefore, the front portion of the sifting and pouring insert 500 begins to move downward. The position catches 810 temporarily disengage with the upper position detents 810. The downward movement of the front portion of the sifting and pouring insert 500 causes the position catches 810 to then engage with the middle position detents 820, such that the sifting and pouring insert 500 is temporarily maintained in the sifting position.

As a fourth downward force (or a continuing third downward force) is applied to the front portion of the cap cover 400, the position catches 810 temporarily disengage with the middle position detents 820. The front portion of the sifting and pouring insert 500 then continues to move downward, where the position catches 810 slide along the lower position grooves 815 until the position catches 810 meet and engage with the lower position detents 825, such that the sifting and pouring insert 500 is temporarily maintained in the closed position.

As configured, the present invention provides a dispensing flip cap device 100 that can be adjusted by an individual with the use of only one finger. The dispensing flip can device 100 can be easily moved between the closed position, sifting position, and pouring position without the use of an additional hand or finger. Further, assembly of the components of the dispensing flip cap device 100 permits the exterior pieces (e.g., the cover cap 400 and the housing 700) to be changed to different styles, colors, or shapes while incorporating the same interior pieces (e.g., the sifting and pouring insert 500 and dispensing sleeve 600).

One skilled in the art will recognize that the cap cover 400, sifting and pouring insert 500, dispensing sleeve 600, housing 700, locking system 800, and all of the components and/or element thereof can be made of a variety of suitable materials including, but not limited to, plastic, rubber, metal, ceramic, or other suitable materials or a combination thereof.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A dispensing cap for a container comprising:
a dispensing sleeve operable for attaching to an open top of the container;
a sifting and pouring insert including a plurality of dispensing apertures, the sifting and pouring insert pivotally mounted in a recess of the dispensing sleeve; and
a cap cover affixed to a top of the sifting and pouring inset, wherein the sifting and pouring insert selectively exposes one or more of the plurality of dispensing apertures.

2. The dispensing cap for a container of claim 1, further comprising a housing slidably disposed on the container, the housing removably affixable to the dispensing sleeve.

3. The dispensing cap for a container of claim 1, wherein the plurality of dispensing apertures includes at least two apertures of different size.

4. The dispensing cap for a container of claim 1, further comprising a locking system designed to affix the position of the sifting and pouring insert relative to the dispensing sleeve.

5. The dispensing cap for a container of claim 4, wherein the locking system includes a first locked position, which corresponds to exposing none of the plurality of dispensing apertures.

6. The dispensing cap for a container of claim 4, wherein the locking system includes a second locked position, which corresponds to exposing a portion of the plurality of dispensing apertures.

7. The dispensing cap for a container of claim 4, wherein the locking system includes a third locked position, which corresponds to exposing all of the plurality of dispensing apertures.

8. The dispensing cap for a container of claim 4, wherein the locking system is temporarily disengaged by a force exerted on cap cover.

9. The dispensing cap for a container of claim 2, wherein the housing prevents rotational movement of the dispensing sleeve during use of the dispensing cap.

10. A method for dispensing comprising:
affixing a dispensing sleeve to an open top of a container;
mounting a sifting and pouring insert including a plurality of dispensing apertures in a recess of the dispensing sleeve, wherein the sifting and pouring insert is pivotally mounted;
attaching a cap cover to a top of the sifting and pouring inset;
pivoting the sifting and pouring insert to selectively expose one or more of the plurality of dispensing apertures; and
dispensing a plurality of particulates from the container through the selectively exposed dispensing apertures.

11. The method of claim 10, wherein the plurality of dispensing apertures includes at least two apertures of different size.

12. The method of claim 10, further comprising increasing a rate of dispensing of particulates by pivoting the sifting and pouring insert to selectively expose all of the plurality of dispensing apertures.

13. The method of claim 10, further comprising pivoting the sifting and pouring insert such that all of the plurality of dispensing apertures are covered by the dispensing sleeve.

14. The method of claim 10, wherein the pivoting of the sifting and pouring inset and the dispensing of the plurality of particulates is capable of being preformed with a single hand.

15. The method of claim 10, further comprising affixing a housing to the dispensing sleeve, the housing being slidably disposed on the container.

16. The method of claim 15, wherein the housing prevents rotational movement of the dispensing sleeve during use.
